(19) United States
(12) Patent Application Publication
(10) Pub. No.: US 2006/0273136 A1
(43) Pub. Date: Dec. 7, 2006

(54) Agitator for mixing hair coloring dye

(76) Inventor: Helmuth G. Bachman, Salinas, CA (US)

Correspondence Address: Helmuth G. Bachmann, 1841 London Way, Salinas, CA, 93906, US

(21) Appl. No.: 10/942,405

(22) Filed: Sep. 15, 2004

(51) Int. Cl. A47J 36/02

(52) U.S. Cl. 228/101

(57) ABSTRACT

A generally cylindrical non-spherical dense body having rib members, used for agitating hair coloring dye within a mixing and application hair coloring dye container. When the container is shaken, the agitator travels randomly inside the container agitating the hair coloring dye liquids together and more thoroughly mixing the entire contents of the container. The shape of the agitator and protruding ribs improve agitation and prevent the blockage of the container applicator orifice when applying the hair coloring dye. The agitator can be dropped into the hair coloring dye container or provided with the container.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention relates to the use of an agitator for mixing hair coloring dyes comprised of a two or more part mixture within a container manually shaken for mixing and application.

2. Description of State of the Art

Most common consumer hair coloring dyes are comprised of a two part mixture, a high viscous liquid and lower viscous liquid. One of the liquids is added to the other in a mixing and application container which is sealed with a screw on top. The liquids in the container are manually shaken by hand using a reciprocation motion to mix the contents. Because of the limited rotational or liner motion used for mixing and the relatively high viscosity of the liquids, mixing is often incomplete within a reasonable period of time. The chemicals in the hair coloring dye are not completely mixed together and will not react uniformly when applied to the hair. This will result in uneven hair dying process with different shades of color in different areas of the hair, or unnatural hair coloring.

One of the most economical methods for mixing liquids is with agitators, which are widely used to mix solid particles, pigments and solvents for spraying purposes. Small spherical balls are generally used to reach the acutely angled corners of the can and are permanently sealed into the can during the manufacturing process. U.S. Pat. No. 5,544,960 discloses a larger generally spherical agitator which is placed in a container and used to agitate or stir solid foodstuffs in powdered form with liquid foodstuffs. The use of any similarly shaped spherically agitators would aid in mixing hair coloring dye, although, for the application of the hair coloring dye, the mixing container is held in an inverted position and the mixing agitator would drop into the conical entry of the applicator cap orifice at the lower end of the container. The spherically shaped agitator would seal against the circular surface of the orifice entry and block the flow or application of the hair coloring dye.

### BRIEF SUMMARY OF THE INVENTION

It is the general object of the present invention to provide an agitator for mixing hair coloring dye, to provide a method to thoroughly mix hair coloring dye within a mixing and application hair coloring dye container more effectively then the state of the art.

It is a further object to the present invention to provide an agitator for mixing hair coloring dye which will thoroughly mix and agitate the contents of the hair coloring dye within the hair coloring dye container when shaken manually by hand.

It is a further object to the present invention to provide an agitator for mixing hair coloring dye that will not interfere with the dispensing or application of hair coloring dye when the hair coloring dye container is inverted for application of the hair coloring dye.

It is a further object to the present invention to provide an agitator for mixing hair coloring dye which can be inserted into the hair coloring dye containers of different brands of hair coloring dye.

These and other features and objects of the invention will become apparent from the following detailed description when taken with the accompanying drawings and claims, of which:

### BRIEF DESCRIPTION OF THE SEVERAL VEIWS OF THE DRAWING

FIG. 1 is a lengthwise section through a hair coloring dye container with a perspective view of the agitator moving through the hair coloring dye according to a first embodiment of the present invention.

FIG. 2 is a lengthwise section through a hair coloring dye container with the agitator pressed against the end of the container.

FIG. 3 is a lengthwise section through a hair coloring dye container with the agitator moving through the hair coloring dye in the opposite direction as in FIG. 1

FIG. 4 is a lengthwise section through the top end of the hair coloring dye container body with a perspective view of the agitator.

FIG. 5 is a lengthwise section through the top end of the hair coloring dye container in the application position with the agitator at rest.

FIG. 6 is a front perspective view of the agitator according to a second embodiment of the present invention.

FIG. 7 is a side perspective view of the agitator according to a second embodiment of the present invention.

FIG. 8 is a bottom view of the agitator according to a second embodiment of the present invention.

FIG. 9 is a lengthwise section through the top end of the hair coloring dye container in the application position with a perspective view of the agitator at rest according to a second embodiment of the present invention.

### DETAILED DESCRIPTION OF THE INVENTION

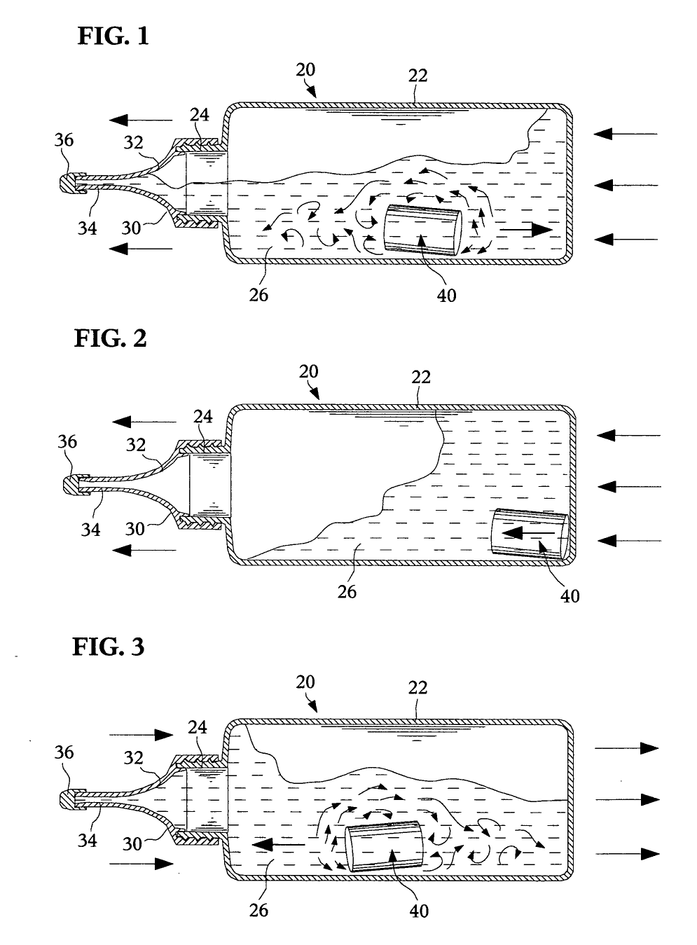

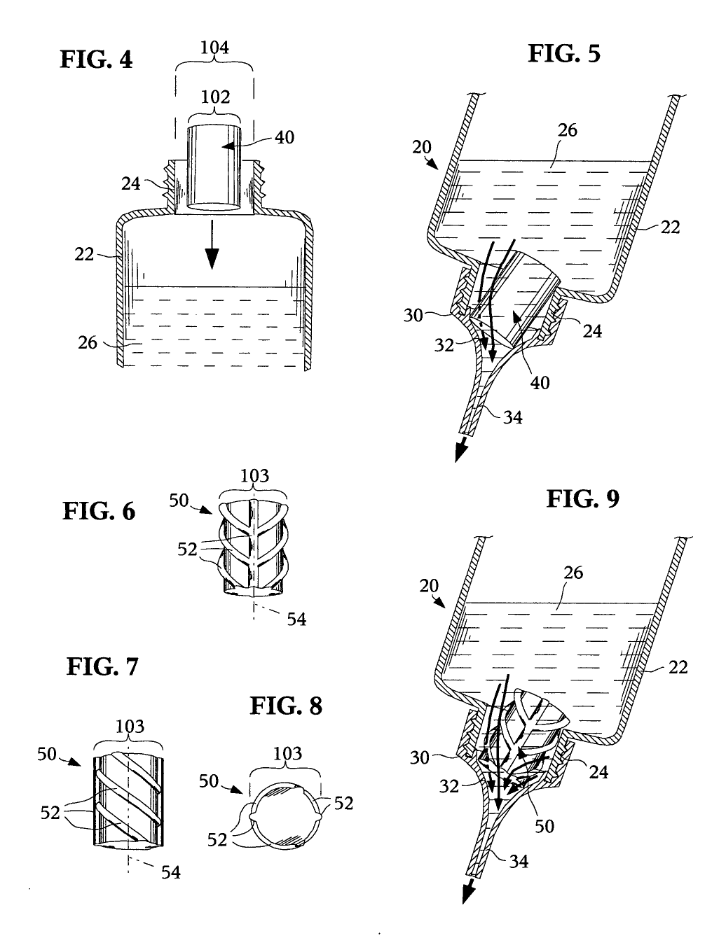

Referring now to the drawings, and more particularly to FIGS. 1 through 9, a mixing agitator 40 provided for mixing a hair coloring dye 26 liquid within a container 20 having a container body 22 and a dispensing applicator cap 30 for applying hair coloring dye 26. The agitator 40 as shown in FIG. 1 is cylindrical in shape and made of a very heavy solid material, preferably steel with a protective coating to prevent rusting and corrosion when stored in a humid bathroom environment. As shown in FIG. 4 the agitator 40 outside diameter size 102 is smaller then the container neck 24 inside diameter size 104 and can easily be dropped into the container body 22 of different hair coloring dye 26 brands when the applicator cap 30 is unscrewed or removed. The agitator 40 could also be provided inside the container 20 by the manufacturer of the hair coloring dye 26 product. With the agitator 40 inside the container 20, the applicator cap 30 is screwed back on to seal in the agitator 40 and the coloring dye 26 in the container 20 and mixed manually by hand with a shaking motion as show in FIGS. 1 through 3. The reciprocating motion accelerates the agitator 40 with the container 20 as shown in FIG. 2 and in the opposite direction of the container 20 through the hair coloring dye 26 with the combined opposing velocities as shown in FIGS. 1 and 2. The high velocity of the mixing agitator 40 and the random motion thorough the hair coloring dye 26 creates turbulence which mixes and agitates the hair coloring dye 26 along the full length of the container 20. The large size and cylindrical shape of the agitator 40 with a long body and edges rotates through the coloring dye 26 to generate more turbulence then spherical ball agitators commonly used in spray cans. Also, unlike spherical balls the cylindrical shape of the agitator 40 as shown in FIG. 5 prevents the blockage of the applicator cap orifice entry 32 when the container 20 is inverted during the application or dispensing of hair coloring dye 26 through the applicator cap orifice 34. A spherical ball would seal against the circular surface of the applicator cap orifice entry 32 and block the flow of hair coloring dye 26 to the applicator cap orifice 34. The applicator cap tip 36 is removed during the application or dispensing the hair coloring dye 26.

In a second embodiment of the invention a ribbed agitator 50 as shown in FIGS. 6 through 8 having a rib member 52 comprised of a plurality of evenly spaced ribs protruding along the cylindrical surface of the ribbed agitator 50 at a 45 degree angle from the longitudinal axis 54 with intercepting longitudinal ribs parallel to the longitudinal axis 54 one on each side of the ribbed agitator 50 as shown. The ribbed outside diameter size 103 of the ribbed agitator 50 is also smaller then the container neck 24 inside diameter size 104 and can easily be dropped into the container body 22 of different hair coloring dye 26 brands when the applicator cap 30 is unscrewed. The surface of the ribbed agitator 50 with the rib member 52 helps generate additional turbulence when moving though the hair coloring dye 26. The rib member 52 extends to the edges of the cylindrical shape and further helps to keep the body of the ribbed agitator 50 from sealing against the circular surface of the applicator cap orifice entry 32 and allows the flow of hair coloring dye 26 around the ribbed agitator 50 to the applicator cap orifice 34 as shown in FIG. 9.

The present invention has been fully described by way of example with the accompanying drawings. Various alternations and changes can be made without departing from the spirit and broader aspects of the invention as set forth in the appending claims, which are to be interpreted in accordance with the principles of patent law including the doctrine of equivalents.

I claim:

1. A mixing and agitating unit for placement with a hair coloring dye in a container to be manually shaken to thoroughly mix said hair coloring dye for application through a dispensing orifice, with said mixing and agitating unit comprising:
a heavy body having a surface shape and a dimension that will fit into said container of different manufacturers of said hair coloring dye and permit the flow of said hair coloring dye around said body and through said dispensing orifice when said container is inverted for the application of said hair coloring dye.

2. A mixing and agitating unit recited in claim 1 wherein said body is comprised of a cylindrical shape.

3. A mixing and agitating unit recited in claim 2 wherein said body is comprised of said cylindrical shape having a plurality of rib members on the surface of said body.

4. A mixing and agitating unit recited in claim 3 further in which said plurality of rib members are symmetrical on each side of said body about the longitudinal axis of said body.

5. A mixing and agitating unit recited in claim 4 further in which said plurality of rib members comprised of a plurality of evenly spaced ribs along the cylindrical surface of said body running parallel to each other and intercepting two longitudinal ribs parallel to the said longitudinal axis of said body with each said longitudinal rib on opposite sides of said body.

6. A mixing and agitating unit recited in claim 5 further in which said plurality of rib members comprised of a plurality of evenly spaced ribs along the cylindrical surface of said body running parallel to each other at a 45 degree angle from the said longitudinal axis of said body and intercepting two said longitudinal ribs parallel to the said longitudinal axis of said body with each said longitudinal rib on opposite sides of said body.

7. A mixing and agitating unit recited in claim 6 further in which said plurality of rib members truncate at the planar ends of said body.

8. A mixing and agitating unit recited in claim 7 further in which said planar ends are perpendicular to said longitudinal axis of said body.

9. A mixing and agitating unit recited in claim 1 wherein said body is made of steel.

10. A mixing and agitating unit recited in claim 9 further in which said steel is a low-medium grade steel.

11. A mixing and agitating unit recited in claim 9 further in which said steel for said body is made using the rolling mill process of fabrication.

12. A mixing and agitating unit recited in claim 9 wherein said body is coated to prevent said body from corroding and rusting in a humid environment.

13. A mixing and agitating unit recited in claim 9 wherein said body is painted to prevent said body from corroding and rusting in a humid environment.

14. A mixing and agitating unit recited in claim 1 wherein said body is made of a plastic with the injection molding process of fabrication having internal objects greater in density then said plastic.

15. A mixing and agitating unit recited in claim 1 wherein said body is provided inside said container by the manufacturer of the said hair coloring dye.
